(19) United States
(12) Patent Application Publication
(10) Pub. No.: US 2024/0117240 A1
(43) Pub. Date: Apr. 11, 2024

(54) Formulations Containing Non-Ionic Surfactants as Emulsion-Modifiers in Oil Treatments

(71) Applicant: Sasol Chemicals GmbH, Hamburg (DE)

(72) Inventors: Khatere Sokhanvarian, Houston, TX (US); Cornell Stanciu, Westlake, LA (US); Jorge Fernandez, Westlake, LA (US)

(21) Appl. No.: 18/548,219

(22) PCT Filed: Mar. 1, 2022
(86) PCT No.: PCT/US2022/018320

§ 371 Date: Aug. 29, 2023

Related U.S. Application Data
(60) Provisional application No. 63/158,433, filed on Mar. 9, 2021.

(51) Int. Cl. C09K 8/584

(52) U.S. Cl. CPC C09K 8/584

(57) ABSTRACT

A formulation according to the invention that can be utilized in the prevention and/or resolving of water and oil emulsions, is described. These formulations have been found to modify water and oil emulsions, and to be very effective non-emulsifiers/weak emulsifiers and/or demulsifiers, specifically in high brine or highly acidic environments, for water and crude oil emulsions. The formulation comprises at least one ethoxylated alcohol with a molecular structure as shown in formula 1: R—O—(C₂H₄O)ₙ—H (1) wherein R comprises linear or branched alkyl groups having from 6 to 18 carbon atoms and n is from 3 to 20.

### CROSS-REFERENCE TO RELATED APPLICATIONS

This application claims priority to U.S. Application No. 63/158,433 filed on Mar. 9, 2021, the disclosure of which is incorporated herein by reference for all purposes.

### FIELD OF THE INVENTION

The present invention relates to formulations containing non-ionic surfactants or mixtures thereof and the use of such formulations for the prevention, breakage/resolving or modification of emulsions. More specifically, the non-ionic surfactants relate to linear, branched or semi-branched alcohol alkoxylates, to be used together with solvents in formulations as non-emulsifiers, demulsifiers or weak emulsifiers in aqueous solutions, to prevent and/or resolve high brine/seawater emulsions with oil, and/or emulsions in acidic water/oil emulsions.

### BACKGROUND OF THE INVENTION AND DISCUSSION OF THE PRIOR ART

Oil production is often associated with water production. Stimulation operations such as hydraulic fracturing, matrix acidizing or acid fracturing, use large volumes of water which, once in contact with the crude oil, can generate numerous problems. These problems range from formation damage, viscosity increase to emulsion formation. The latter is an undesired effect as it can further damage the formation and reduce its permeability as well as pose huge challenges to recover the oil once at the surface. Some emulsions can be very stable, particularly the acid emulsions, due to strong and complex interactions between the aromatic and polyaromatic hydrocarbons with oxygenated species in the acidic medium and in the presence of various metal salts, resins and asphaltenes. Therefore, their separation can induce significant extra costs. In reservoirs subjected to enhanced oil recovery (EOR) operations, when processes such as water flooding (WF), alkali polymer flooding (AP) or alkali surfactant polymer flooding (ASP) are used, the amounts of produced water (PW) can be very large, reaching ratios of 9:1 or higher water:oil. There is thus a high need for products such as non-emulsifiers (NE), weak emulsifiers (WE) or demulsifiers (DE) to be injected along with different treatments applied to the formation or to the wellbore to avoid or minimize the emulsion formation. Once at the surface, further products such as demulsifiers (DE) could typically also be needed to break the emulsions that do form in order to recover the oil and to ensure a minimal treatment of the produced water (PW) before it can be reused or disposed of.

Many non-emulsifier, weak emulsifier, or demulsifier products available on the market have high degrees of toxicity or are hazardous. A number of commercial products are based on formaldehyde, phenol-formaldehyde resins, amines, quaternary salts, polyamines or polyimines, and are often formulated in benzene, toluene, ethylbenzene, or xylene solvents (BTEX solvents). These formulations are obviously not environmentally friendly options. In addition, many compositions that are described to provide application possibilities over a wide range of circumstances, are complex and expensive formulations.

Typical emulsion-modifiers are described in U.S. Pat. No. 2,499,370 (oxyalkylated alkyl phenol resins) and U.S. Pat. No. 4,537,701 (oxyalkylated isoalkylphenol-formaldehyde resins and oxyalkylated polyalkylenepolyamines). More recently, complex compositions comprising demulsifiers or ionic surfactants are described such as salts of alkylaryl sulfonic acid and bisphenol glycol ethers/esters, in combination with solubilizing nonionic surfactants and second solubilizing solvents such as glycol ethers, amides, ketones or alcohols (US 2003/0032683). Anionic surfactants used in demulsifier compositions such as alkylsulfosuccinates, alkylphosphonic acids and their salts, together with nonionic surfactants and solvents such as dibasic esters are described in US 2009/0149557. WO 20131588989 describes nonionic demulsifiers such as polyethyleneimine alkoxylates and cross-linked ethylene oxide/propylene oxide copolymers, in combination with nonionic, cationic, anionic and amphotheric surfactants, as well as coupling agents/solvents such as diols, alkyl ethers of alkylene glycols or alcohols. All references listed in this paragraph are incorporated herein by reference for all purposes.

Providing universal emulsion-modifier formulations for all grades of crude oil and various downhole situations (such as high brine/high acidic environments) is very challenging because of the different constitution of various crude oils and variations in the downhole environment (such as for example, high brine or strongly acidic environments). Nevertheless, it is desirable to provide emulsion-modifier formulations which are applicable to a plurality of situations, in order to avoid the need for excessively large numbers of products for effective emulsion prevention/modification.

Additionally, besides the traditional oilfield and petrochemical markets, there is a possibility of extending the reach of novel emulsion-modifier products into other markets where emulsion formation is also an undesired phenomenon. Such markets can include, but are not limited to, metalworking lubricants (MWL), inks, paints and coatings (IPC), oil-based power plants, cotton-seed oils, pharmaceuticals and agrochemicals, such as pesticide technology areas.

There is therefore an ongoing need for simple, stable, low cost, environmentally friendly emulsion-modifier formulations for effective and general application in the chemical, oilfield and general industrial technology areas, as well as in household and agrochemical industries.

### Object of the Present Invention

It is an object of this invention to provide non-emulsifier/weak emulsifier/demulsifier formulations for enhanced emulsion-prevention or the resolving of emulsions in aqueous solutions during the treatment of subterranean formations, to subsequently result in effective oil recovery.

It is another object of this invention to provide simple, stable and environmentally friendly emulsion-modifier systems comprising ethoxylated alcohols and solvents for effective emulsion-prevention or the resolving of emulsions in aqueous solutions, of water and oil emulsions in a high brine or highly acidic environment, having applicability within a wide range of crude oils.

### SUMMARY OF THE INVENTION

In the following, a formulation according to the invention that can be utilized in the prevention and/or resolving of water and oil emulsions, is described. These formulations have been found to modify water and oil emulsions, and to be very effective non-emulsifiers/weak emulsifiers and/or demulsifiers, specifically in high brine or highly acidic environments, for water and crude oil emulsions.

The formulation comprises at least one ethoxylated alcohol with a molecular structure as shown in formula 1:

R—O—(C₂H₄O)ₙ—H (1)

wherein R comprises linear or branched alkyl groups having from 6 to 18 carbon atoms, more preferably 6 to 16 carbon atoms, most preferably 6 to 13 carbon atoms, and n is from 3 to 20, more preferably from 3 to 18, most preferably from 3 to 15.

Additionally, the formulation also comprises at least one solvent selected from a group of alcohols, a group of ethers, or mixtures thereof. The solvent, preferably in the liquid phase, is selected from a group of alcohols having the formula R¹—OH, wherein R¹ is a linear or branched alkyl chain, or a cyclic group, having from 1 to 20 carbon atoms, more preferably from 1 to 12 carbon atoms, or wherein the solvent is selected from a group of ethers consisting of alkylene glycol ethers or alkyl ethers.

In a preferred embodiment, the formulation comprises at least two solvents, both in the liquid phase, selected from the groups of alcohols and/or ethers. At least one of the solvents is an alcohol having the formula R¹—OH, wherein the alkyl group R¹ is branched in the 2-position, the alkyl chain having from 12 to 20 carbon atoms, more preferably from 12 to 16 carbon atoms or most preferably from 12 to 14 carbon atoms.

The formulations have been proven to be effective in brine or acidic environments, specifically high brine environments with a content of up to 150000 total dissolved solids (TDS), more preferably up to 130000 TDS, most preferably up to 120000 TDS, with a pH of up to 10.

The inventive formulations have also been proven to be effective in highly acidic environments of up to 30 wt % acid, e.g. HCl, more preferably up to 20 wt % acid, most preferably up to 15 wt % acid, with a pH of down to 2.

In an embodiment of the current invention, pH values of the working environment will range from 2 to 12, more preferably from 2 to 10, most preferably from 4 to 10. Thus, the current invention will work in acidic environments having a pH of 2 to 7, preferably 4 to 7, and in brine environments having a pH of from greater than 7 to 12, preferably from greater than 7 to 10.

The formulation could potentially further comprise water up to 99.9 wt %. It follows from the environment where the inventive formulations can potentially be used, that the water could be field water, recovered from underground reservoirs or obtained from recovery operations.

In a preferred embodiment, the formulation comprises at least two different ethoxylated alcohols, the ethoxylated alcohols having the structure as shown in formula (1). Preferably, the formulation comprises an ethoxylated alcohol wherein R is a linear alkyl chain having from 6 to 10 carbon atoms, and another ethoxylated alcohol wherein R is a branched alkyl chain, having from 10 to 18 carbon atoms.

The formulation preferably contains ethoxylated alcohol or alcohols from about 10 wt % to about 60 wt %, of the combined ethoxylated alcohol or alcohols and solvent or solvents content.

In a highly preferred embodiment, the formulation would comprise at least one ethoxylated alcohol having the structure of formula 1 above, and at least one solvent, selected from the said group of alcohols or ethers, or mixtures thereof, incorporating the embodiments described above.

Another embodiment of the current invention is a method for preventing or resolving water and oil emulsions, comprising
i) providing a formulation comprising:
   a) at least one ethoxylated alcohol having the following structure:

R—O—(C₂H₄O)ₙ—H (I)
wherein R comprises linear or branched alkyl groups, having from 6 to 18 carbon atoms;
   n is from 3 to 20; and
   b) at least one solvent, selected from a group of alcohols, a group of ethers, or mixtures thereof;
ii) contacting the formulation described in i) above with a high brine or highly acidic water and oil emulsion, in a concentration effective to prevent or resolve the water and oil emulsion.

This method for preventing or resolving water and oil emulsions would include all embodiments and preferred embodiments of the inventive formulations described above.

Also claimed is the use of a formulation for preventing or resolving water and oil emulsions, the formulation comprising:
i) at least one ethoxylated alcohol having the following structure:

R—O—(C₂H₄O)ₙ—H (I)
wherein R comprises linear or branched alkyl groups, having from 6 to 18 carbon atoms;
   n is from 3 to 20; and
ii) at least one solvent, selected from a group of alcohols, a group of ethers, or mixtures thereof;
the formulation being effective in high brine or highly acidic, water and oil emulsions.

The use of the inventive formulation for preventing or resolving water and oil emulsions would include all embodiments and preferred embodiments of the said formulations described above.

Unlike the prior art, the present invention is described as a simple formulation comprising environmentally friendly ethoxylated alcohols and solvents, which can be used both as a micro-emulsion or alternatively in a 100% active format. There is no need to add additional surfactants such as anionic, cationic or amphoteric surfactants; Nor is there a need to add additional demulsifiers such as phenol-formaldehyde resins, polyamines etc. or environmentally unfriendly BTEX solvents. In a preferred embodiment, the present invention is the only non-emulsifier/weak emulsifier/demulsifier employed and is used in the absence of any additional demulsifiers or environmentally unfriendly solvents. The inventive formulations consist of small molecules, having low viscosities and low pour points, providing desirable advantages above polymer-based formulations such as ease of handling over a range of temperatures. In addition, problems caused by polymer-based compositions such as formation damage downhole, are avoided. The formulations described are effective in both high brine and highly acidic environments, and can be used with a wide variety of crude oils, ranging from light grades (with low % of asphaltenes) to heavy grade (with high % of asphaltene) oils.

These and further features and advantages of the present invention will become apparent from the following detailed description.

### BRIEF DESCRIPTION OF THE DRAWINGS

FIG. 1 shows sludge and emulsion formation upon mixing of crude oil and synthetic seawater.

FIG. 2 shows the performance of an inventive emulsion-modifier formulation (100% active and 0.1 wt % active/micro-emulsion) with Lagoa do Paulo crude (medium grade oil) in a high brine environment.

FIG. 3 shows the particle size of a micro-emulsion as a function of frequency.

### DETAILED DESCRIPTION OF PREFERRED EMBODIMENTS

The formulations of the current invention are effective non-emulsifiers, weak emulsifiers and/or demulsifiers for a wide variety of applications. The performance of the compositions can be optimally designed by tailoring the hydrophobe structures of the surfactant compounds, the alkyl chain being branched or linear and carbon numbers ranging between C6-C18, together with the number of ethylene oxide (EO) units (between 3-20 units), as well as the choice of solvent/co-solvent/co-emulsifier being selected from alcohols and/or ethers for a specific application area, in particular for high brine/crude oil emulsions and acidic water/crude oil emulsions. The weight % composition of the various compounds in the emulsion-modifier formulation, as well as the amount of formulation used provide additional tailoring opportunities. The formulations provide effective emulsion-modifier performance in highly acidic and high brine environments (containing a high concentration of divalent cations). They have also proven to be effective for a range of crude oils having various saturate, aromatic, resin and asphaltene (SARA) compositions.

When considering well-known prior art formulations, it is clear that the current invention does not need the addition of any polymer-based compositions or compounds, typically, but not limited to, oxyalkylated isoalkylphenol-formaldehyde resins, oxyalkylated polyalkylenepolyamines and cross-linked ethylene oxide/propylene oxide copolymers. The current invention's polymer-free formulations are therefore easy to handle and will not result in downhole formation damage.

### Materials

A number of non-ionic surfactants, specifically ethoxylated alcohols, were synthesized according to standard procedures (see Experimental section) and their properties characterized. The materials used in various tests to determine the efficiency of the compounds as emulsion-modifiers, are shown in Table 1:

TABLE 1
Materials used to evaluate emulsifying properties
ETHOXYLATED ALCOHOLS

| | Derived | | | Ethylene | |
|---|---|---|---|---|---|
| Surfactant | from Alcohol | Alcohol carbon- | | oxide (EO) | HLB* |
| (Trade Name) | (Trade Name) | chain length | Alcohol structure | Units | Values |
| TERRAVIS K1-3 | ALFOL6 | C6 | Linear | 3 | 11.3 |
| (NOVEL6-3) | | | | | |
| TERRAVIS K1-15 | ALFOL6 | C6 | Linear | 15 | 17.3 |
| (NOVEL6-15) | | | | | |
| TERRAVIS K1-20 | ALFOL6 | C6 | Linear | 20 | 17.9 |
| (NOVEL6-20) | | | | | |
| TERRAVIS K2- | ALFOL8 | C8 | Linear | 7 | 14.1 |
| 7(NOVEL8-7) | | | | | |
| TERRAVIS S3 | SAFOL23 | C1213 | 50% branched | 3 | 8.1 |
| (NOVEL23E3) | | | (2.16 branch/ | | |
| | | | molecule) | | |
| TDA-8 | TDA alcohol | C13 | Trimethyldecanol | 8 | 12.7 |
| | (Isotridecanol) | | | | |
| ISOFOL12-4 | ISOFOL12 | C12 | 100% 2-alkyl | 4 | 9.7 |
| | | | branched (1.0 | | |
| | | | branch/molecule) | | |

SOLVENTS/CO-SOLVENTS/CO-EMULSIFIERS

| Type | Trade Name | C-chain length | Structure |
|---|---|---|---|
| Alcohol | ALFOL6 | C6 | Linear |
| Alcohol | ISOFOL12 | C12 | 100% 2-alkyl |
| | | (Guerbet) | branched (1.0 |
| | | | branch/molecule) |
| Alcohol | Cyclohexanol | C6 | Cyclic |
| Alcohol | Octanol (RSA 8+) | C8 | Linear |
| Ether | NACOL ether6 | C6 | Linear |
| Ether | Ethylene glycol | C2-4 | Linear |
| | butyl ether | | |

FORMULATIONS

| NE/WE/DE Composition | | | | | |
|---|---|---|---|---|---|
| | | | Co-solvent/ | De-ionised | Co-emulsifier |
| ETHOXYLATED ALCOHOLS | | Solvent | co-emulsifier | (DI) water | in DI water |
| TERRAVIS K1-15 | TERRAVIS S3 | ALFOL6 | — | 99.9 wt % | — |
| (30 wt %) | (30 wt %) | (40 wt %) | | | |
| TERRAVIS K1-15 | TERRAVIS S3 | ALFOL6 | NACOL | 99.9 wt % | — |
| (10 wt %) | (10 wt %) | (40 wt %) | ether6(40 wt %) | | |
| TERRAVIS K1-15 | TERRAVIS S3 | ALFOL6 | — | 94.9 wt % | Ethylene |
| (13.3 wt %) | (6.7 wt %) | (80 wt %) | | | glycol butyl |
| | | | | | ether(5 wt %) |
| TERRAVIS K1-3 | TERRAVIS S3 | ALFOL6 | — | 99.9 wt % | — |
| (7.5 wt %) | (7.5 wt %) | (85 wt %) | | | |
| TERRAVIS K1-3 | TERRAVIS S3 | ALFOL6 | — | 90 wt % | — |
| (7.5 wt %) | (7.5 wt %) | (85 wt %) | | | |
| TERRAVIS K1-3 | TERRAVIS S3 | ALFOL6 | — | — | — |
| (7.5 wt %) | (7.5 wt %) | (85 wt %) | | | |
| TERRAVIS K1-3 | TERRAVIS S3 | ALFOL6 | ISOFOL 12 | 99.9 wt % | — |
| (7.5 wt %) | (7.5 wt %) | (50 wt %) | (35 wt %) | | |
| TDA-8 (33.3 wt %) | — | Cyclohexanol | — | — | — |
| | | (66.7 wt %) | | | |
| TERRAVIS K2-7 | — | NACOL ether6 | — | — | — |
| (33.3 wt %) | | (66.7 wt %) | | | |
| TERRAVIS K1-20 | — | NACOL ether 6 | — | — | — |
| (33.3 wt %) | | (66.7 wt %) | | | |
| TERRAVIS S3 | — | NACOL ether6 | — | — | — |
| (50 wt %) | | (50 wt %) | | | |
| TERRAVIS S3 | — | NACOL ether6 | — | — | — |
| (33.3 wt %) | | (66.7 wt %) | | | |
| TERRAVIS K1-20 | — | Cyclohexanol | — | — | — |
| (50 wt %) | | (50 wt %) | | | |
| TDA-8 (33.3 wt %) | — | NACOL ether6 | Cyclohexanol | — | — |
| | | (33.3 wt %) | (33.3 wt % | | |
| ISOFOL 12-4 | — | NACOL ether6 | | | |
| (33 wt %) | | (66.7 wt %) | | | |
| TERRAVIS K1-15 | TERRAVIS S3 | NACOL ether6 | — | — | — |
| (16.7 wt %) | (16.6 wt %) | (66.7 wt %) | | | |
| TERRAVIS K1-15 | TERRAVIS S3 | Cyclohexanol | — | — | — |
| (16.7 wt %) | (16.6 wt %) | (66.7 wt %) | | | |
| TERRAVIS K1-15 | TERRAVIS S3 | ALFOL 6 | — | — | — |
| (16.7 wt %) | (16.6 wt %) | (66.7 wt %) | | | |
| TERRAVIS K2-7 | TERRAVIS S3 | NACOL ether6 | — | — | — |
| (16.7 wt %) | (16.6 wt %) | (66.7 wt %) | | | |

*HLB refers to the Hydrophile-Lipophile Balance

Table 2 shows the physical properties of the crude oils that were tested.

TABLE 2
Crude oils used to test effectiveness of non-emulsifiers/weak emulsifiers/demulsifiers

| | | | | | | | Density |
|---|---|---|---|---|---|---|---|
| | | % | % | % | % | API | (g/ml) @ |
| Field | <C15 | Saturates | Aromatics | Resin | Asphaltenes | Gravity | 20° C. |
| Ranger | 55.46 | 60.13 | 32.29 | 7.35 | 0.22 | 38.1 | 0.8344 |
| USA | | | | | | | |
| (light grade) | | | | | | | |
| Lagoa do | 21.5 | 64.8 | 19.05 | 15.82 | 0.34 | 30.5 | 0.8735 |
| Paulo | | | | | | | |
| BRAZIL | | | | | | | |
| (medium grade) | | | | | | | |
| Leitchville | 26.62 | 22.97 | 51.82 | 16.67 | 8.54 | 22.3 | 0.9201 |
| CANADA | | | | | | | |
| (heavy grade) | | | | | | | |

### EXPERIMENTAL SECTION

### Synthesis of Ethoxylated Alcohols Used for the Experiments

Alcohols with carbon chain lengths ranging from C6-13 were ethoxylated utilizing alkoxylation catalysts such as Sasol's proprietary NOVEL catalyst or well-known KOH catalysts according to standard ethoxylation procedures. Each ethoxylated alcohol product was targeted to contain between 3-15 moles of ethylene oxide (EO). The samples were prepared in a 600 ml Parr reactor using the alkoxylation catalyst of choice. Each alcohol was ethoxylated using purified ethylene oxide at 150-160° C. and 40-60 psig in a single, continuous run.

A. Tests Performed Using Emulsion-Modifier Formulations in High Brine Environments

The non-emulsifier (NE)/weak emulsifier (WE)/demulsifier (DE) formulation comprised at least one alcohol ethoxylate and at least one solvent.

### Procedure:

1. Mix the NE/WE/DE formulation with 50 ml of synthetic seawater (see composition below in Table 3).
2. Heat the crude oil to 65° C.
3. Add 50 ml of crude oil to the mixture of synthetic seawater and NE/WE/DE formulation
4. Shake the bottle for 30 seconds, and then heat it to 65° C.
5. Monitor separation percentage as a function of time by visual inspection and measurement of height by ruler.

TABLE 3
Composition of synthetic seawater used for experiments*

| Salt | g/10 L |
|---|---|
| NaCl | 940 |
| CaCl₂•2H₂O | 191.5 |
| MgCl₂•6H₂O | 52.5 |
| KCl | 17 |
| SrCl₂ | 14.5 |
| NaHCO₃ | 3.5 |

*Total dissolved solids (TDS) = 121 900

Various formulations were tested as a potential NE/WE/DE for fracturing treatment in a high brine environment. The purpose was to develop a formulation that is functional when added as 100% active formulation (no dilution with water), as well as when highly diluted in de-ionised (DI) water (resulting in the formation of a micro-emulsion).

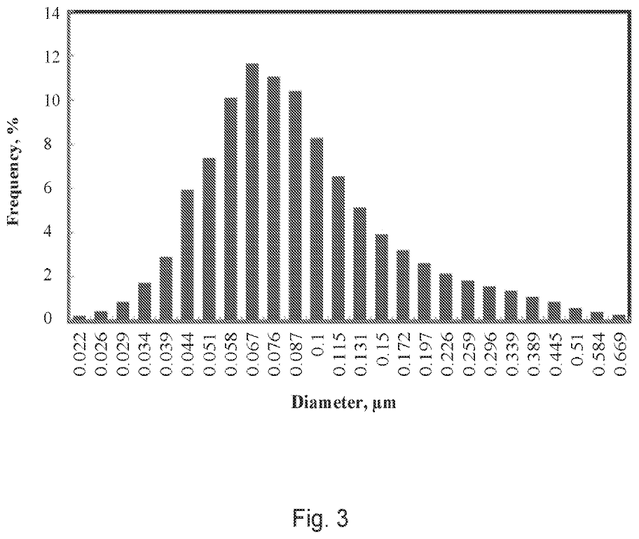

Different formulations were tested as an effective emulsion-modifier for 1:1 ratio (volume %) of crude oil to synthetic seawater/NE/WE/DE formulation. Tables 4 and 5 summarize the performance of the various formulations tested in the present study for Lagoa do Paulo crude and Leitchville crude, respectively. The best-performing candidate displaying favorable results was subsequently compared against a control sample (containing no emulsion-modifier formulation). Furthermore, the particle size of the micro-emulsion was determined using Laser Scattering (LA-930-HORIBA instrument). The particle size distribution of the micro-emulsion formed can be seen in FIG. 3.

TABLE 4
Summary of different emulsion-modifier formulations used with Lagoa
do Paolo crude (medium grade oil).

| | | | Concentration | |
|---|---|---|---|---|
| | | | of micro | |
| | | | emulsion/neat | |
| | | | formulation | |
| | Diluted in | Active wt % of | added to | |
| | continuous | NE/WE/DE in | synthetic | |
| Formulation | phase | micro emulsion | seawater, gpt* | Observation |
| Blank crude + synthetic | Not | Not | Not | No separation-very bad |
| seawater | applicable | applicable | applicable | sludge/emulsion |
| 40 wt % ALFOL 6 + | DI water | 0.1 | 30 | No separation was observed and |
| 30 wt % TERRAVIS K1-15 + | | | | the sludge was present for the |
| 30 wt % TERRAVIS S3 | | | | whole duration of the test |
| 80 wt % ALFOL 6 + | 5 wt % Ethylene | 0.1 | 30 | No separation was observed and |
| 13.3 wt % TERRAVIS K1-15 + | glycol butyl ether + | | | the sludge was present for the |
| 6.7 wt % TERRAVIS S3 | 94.9 wt % DI water | | | whole duration of the test |
| 85 wt % ALFOL 6 + | DI water | 0.1 | 30 | All concentrations were |
| 7.5 wt % TERRAVIS K1-3 + | | | 40 | successful to effectively separate |
| 7.5 wt % TERRAVIS S3 | | | 50 | oil and water |
| | | | | 50 gpt was the optimum loading |
| 85 wt % ALFOL 6 + | No dilution | 100 | 5.2 | Oil and water separated 100% |
| 7.5 wt % TERRAVIS K1-3 + | | | | |
| 7.5 wt % TERRAVIS S3 | | | | |

*gpt = gallons per thousand of gallons; 1 gpt = 0.1 wt %

TABLE 5
Summary of different emulsion-modifier formulations used with
Leitchville crude (heavy grade oil).

| | | | Concentration of | |
|---|---|---|---|---|
| | Diluted | Active % of | micro emulsion | |
| | in | NE/WE/DE | added to synthetic | |
| Micro-emulsion | continues | in micro | seawater, | |
| formulation | phase | emulsion | gpt | Observation |
| Blank crude + synthetic | Not | Not | Not applicable | No separation-very |
| seawaterl | applicable | applicable | | bad sludge/emulsio |
| 50 wt % ALFOL 6 + | DI water | 0.1 | 50 | Oil and water |
| 35 wt % ISOFOL 12 + | | | | separated 100% |
| 7.5 wt % TERRAVIS K1-3 + | | | | after 5 min |
| 7.5 wt % TERRAVIS S3 | | | | |
| 85 wt % ALFOL 6 + | DI water | 10 | 50 | Oil and water |
| 7.5 wt % TERRAVIS K1-3 + | | | | separated 100% |
| 7.5 wt % TERRAVIS S3 | | | | after 5 minutes |

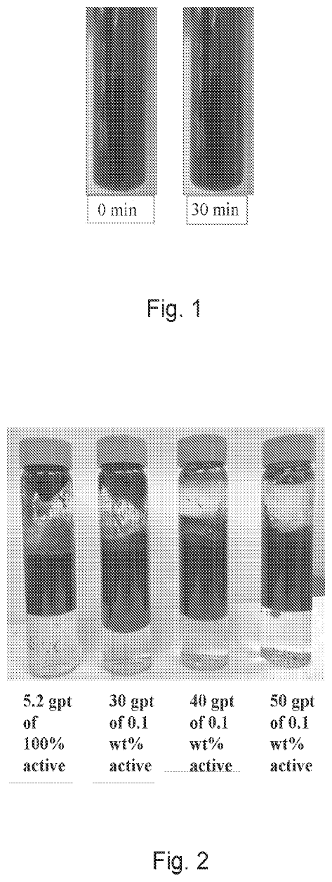

FIG. 1 shows the sludge and emulsion formed upon mixing of Leitchville crude oil and synthetic seawater at 0 minutes and after 30 minutes. It is clear that the emulsion and sludge did not break after 30 minutes.

FIG. 2 shows the performance of emulsion-modifier formulation (85 wt % ALFOL6+7.5 wt %, TERRAVIS K1-3, 7.5 wt % TERRAVIS S3) as 100% active and 0.1 wt % active (micro-emulsion) with Lagoa do Paulo crude (medium grade oil).

If a micro-emulsion is used as emulsion-modifier formulation, 50 gpt is preferred to 30 or 40 gpt. Much lower concentrations are needed when the emulsion-modifier formulation is used in un-diluted form (100% active). For all concentrations, separation started during the first 2-3 minutes.

FIG. 3 shows the particle size of a micro-emulsion (formulation: 50 wt % ALFOL6+35 wt %, ISOFOL12+7.5 wt %, TERRAVIS K1-3, 7.5 wt % TERRAVIS S3) as a function of frequency. The peak is at 0.067 μm, confirming the microemulsion nature of the system.

B. Tests Performed Using Emulsion-Modifier Formulations in Acidic Environments

The test employed throughout the experiments described herein is as follows:
1. Add the NE/WE/DE formulation to 50 ml of 15 wt % HCl (in water) and mix.
2. Heat the crude oil to 65° C.
3. Add 50 ml of the oil to the mixture of NE/WE/DE formulation and 15 wt % HCl in water.
4. Shake the bottle for 30 seconds, and then heat it to 65° C.
5. Monitor separation percentage as a function of time (by visual inspection and measurement of height by ruler).

Various formulations were tested as potential NE/WE/DE formulations for acidizing packages. In order to cover various crude oil types, three different crude oils were evaluated to cover light, medium, and heavy range oils. Table 6 summarizes the performance of different formulations tested in the present study. The best candidate with favorable results was subsequently compared to a control sample (containing no NE//WE/DE formulation).

The best-performing emulsion-modifier formulation (66.7 wt % NACOL ether 6+33.3 wt % TERRAVIS K1-20) was again selected and the experiments were repeated using additional crude oil types (Table 7).

TABLE 6
Summary of different formulations (100% active, no dilution with DI water) in acidic
water, as emulsion-modifiers for the Lagoa do Paulo crude (medium grade oil).

| | | | | | Concentration | |
|---|---|---|---|---|---|---|
| | | | | | of formulation | |
| Non-emulsifier | | Separation % after | | | added to acidic | |
| Formulation | HLB | 5 min | 15 min | 30 min | water, gpt | Observation |
| Blank crude + HCl | NA | 0 | 0 | 0 | NA | No separation |
| 66.7 wt % cyclohexanol + | 12.8 | 32% | Not | 40% | 6 | Crystal clear |
| 33.3 wt % TDA-8 | | | recorded | | | aqueous phase |
| 66.7 wt % NACOL ether 6 + | 14.1 | 64% | 68% | 76% | 6 | Not clear at 5 |
| 33.3 wt % TERRAVIS K2-7 | | | | | | min. almost |
| | | | | | | clear at 30 min |
| 66.7 wt % NACOL ether 6 + | 17.9 | 36% | 40% | 44% | 6 | Crystal clear |
| 33.3 wt % TERRAVIS K1-20 | | | | | | aqueous phase |
| 50 wt % NACOL ether 6 + | 8.3 | 44% | 48% | 56% | 4 | Not clear at 5 |
| 50 wt % TERRAVIS S3 | | | | | | min- almost clear |
| | | | | | | after 30 min |
| 66.7 wt % NACOL ether 6 + | 8.3 | Not | 60% | 68% | 6 | Clear after 30 min |
| 33.3 wt % TERRAVIS S3 | | recorded | | | | |
| 50 wt % cyclohexanol | 17.9 | 56% | 56% | 68% | 4 | Clear after 30 Min |
| 50 wt % TERRAVIS K1-20 | | | | | | |
| 33.3 wt % NACOL ether 6 + | 12.8 | 36% | 60% | 80% | 6 | Clear after 30 |
| 33.3 wt % Cyclohexanol + | | | | | | min, yellowish |
| 33.3 wt % TDA-8 | | | | | | aqueous phase |
| 66.7 wt % NACOL ether 6 + | 9.7 | 60% | 80% | 90% | 6 | Weakly |
| 33.3 wt % ISOFOL 12-4 | | | | | | emulsified |
| 66.7 wt % NACOL ether 6 + | 12.8 | 60% | 60% | 60% | 6 | Almost clear |
| 16.7 wt % TERRAVIS K1-15 + | | | | | | after 30 min |
| 16.6 wt % TERRAVIS S3 | | | | | | |
| 66.7 wt % cyclohexanol + | 12.8 | 68% | 68% | 76% | 6 | Almost clear |
| 16.7 wt % TERRAVIS K1-15 + | | | | | | after 15 min |
| 16.6 wt % TERRAVIS S3 | | | | | | |
| 66.7 wt % ALFOL 6 + | 12.8 | 79% | 80% | 90% | 6 | Almost clear |
| 16.7 wt % TERRAVIS K1-15 + | | | | | | after 5 min |
| 16.6 wt % TERRAVIS S3 | | | | | | |
| 66.7 wt % NACOL ether 6 + | 11.2 | 68% | 68% | 72% | 6 | Almost clear |
| 16.7 wt % TERRAVIS K2-7 + | | | | | | after 30 min |
| 16.6 wt % TERRAVIS S3 | | | | | | |

TABLE 7
The performance of an inventive emulsion-modifier formulation vs. control sample, in Ranger
crude (light grade oil). Formulations were tested as 100% active, no dilution with DI water.

| | | | | | Concentration | |
|---|---|---|---|---|---|---|
| Emulsion- | | | | | of formulation | |
| modifier | | Separation % after | | | added to acidic | |
| Formulation | HLB | 5 min | 15 min | 30 Min | water, gpt | Observation |
| Blank crude + HCl | Not | 96% | 96% | ~100 | | Clear |
| | applicable | | | | | |
| 66.7 wt % ALFOL 6 + | 12.8 | ~100%* | 100% | 100% | 6 | Clear |
| 16.7 wt % TERRAVIS K1-15 + | | | | | | |
| 16.6 wt % TERRAVIS S3 | | | | | | |

*After five minutes, almost 100% separation was achieved.

1. A water and oil emulsion-modifier formulation, the formulation comprising:
i) at least one ethoxylated alcohol having the following structure shown in formula (1):
R—O—(C₂H₄O)ₙ—H (1)
wherein R comprises linear or branched alkyl groups, having from 6 to 18 carbon atoms;
n is from 3 to 20; and
ii) at least one solvent, selected from a group of alcohols, a group of ethers, or mixture thereof;
the formulation being able to prevent or resolve water and oil emulsions in brine or acidic environments, specifically high brine of up to 150000 total dissolved solids or highly acidic of up to 30 wt % acid environments.

2. The formulation of claim 1, where R comprises linear or branched alkyl groups, having from 6 to 16 carbon atoms.

3. The formulation of claim 1, wherein n is from 3 to 18.

4. The formulation of claim 1, wherein the formulation further comprises water up to 99.9 wt %.

5. The formulation of claim 1, wherein said formulation is effective in brine environments of up to 130000 total dissolved solids.

6. The formulation of claim 1, wherein said formulation is effective in environments having a pH of up to 12.

7. The formulation of claim 1, wherein said formulation is effective in acidic environments of up to 20 wt % acid.

8. The formulation of claim 1, wherein said formulation is effective in environments having a pH of down to 2.

9. The formulation of claim 1, wherein the formulation comprises at least two different ethoxylated alcohols, the ethoxylated alcohols having the structure as shown in formula (1).

10. The formulation of claim 1, wherein the formulation comprises an ethoxylated alcohol wherein R is a linear alkyl chain having from 6 to 10 carbon atoms, and another ethoxylated alcohol wherein R is a branched alkyl chain having from 10 to 18 carbon atoms.

11. The formulation of claim 1, wherein the solvent is selected from a group of alcohols having the formula R¹—OH, wherein R¹ is a linear or branched alkyl chain, or a cyclic group, having from 1 to 20 carbon atoms, or wherein the solvent is selected from a group of ethers consisting of alkylene glycol ethers or alkyl ethers.

12. The formulation of claim 1 wherein the formulation comprises at least two solvents, selected from the groups of alcohols and/or ethers.

13. The formulation of claim 1, wherein at least one of the solvents is an alcohol having the formula R¹—OH, wherein the alkyl group R¹ is branched in the 2-position, the alkyl chain having from 12 to 20 carbon atoms.

14. The formulation of claim 1, wherein the ethoxylated alcohol or alcohols are from about 10 wt % to about 60 wt % of the combined ethoxylated alcohol or alcohols and solvent or solvents content.

15. A method for preventing or resolving water and oil emulsions, comprising
i) providing a formulation comprising:
a) at least one ethoxylated alcohol having the following structure:
R—O—(C₂H₄O)ₙ—H (I)
wherein R comprises linear or branched alkyl groups having from 6 to 18 carbon atoms;
n is from 3 to 20; and
b) at least one solvent, selected from a group of alcohols, a group of ethers, or mixtures thereof;
ii) contacting the formulation described in i) above with a brine or acidic water and oil emulsion, specifically a high brine of up to 1500000 total dissolved solids or highly acidic of up to 30 wt % acid, water and oil emulsions, in a concentration effective to prevent or resolve the water and oil emulsion.

16. (canceled)
